(19) United States
(12) Patent Application Publication
(10) Pub. No.: US 2019/0313249 A1
(43) Pub. Date: Oct. 10, 2019

(54) SYSTEMS, DEVICES, AND METHODS TO ESTABLISH ENCRYPTED COMMUNICATIONS BETWEEN WEARABLE ELECTRONIC DEVICES

(71) Applicant: North Inc., Kitchener (CA)

(72) Inventors: Jason T. Griffin, Kitchener (CA); Steven Henry Fyke, Waterloo (CA)

(73) Assignee: North Inc., Kitchener (CA)

(21) Appl. No.: 16/380,204

(22) Filed: Apr. 10, 2019

Related U.S. Application Data
(60) Provisional application No. 62/655,640, filed on Apr. 10, 2018.

(51) Int. Cl. H04W 12/00; H04L 29/06; H04W 12/04

(52) U.S. Cl. CPC H04W 12/00504; H04L 63/0485; H04W 12/0051; H04W 12/04071; H04W 12/003

(57) ABSTRACT

Systems, devices, and methods establish encrypted communications between wearable electronic devices. In response to a physical contact between a first wearable electronic device and a second wearable electronic device respective impact sensors of the first and second wearable electronic devices generate sensor signals. A first identity signal is transmitted from the first wearable device and received at the second wearable device. The second wearable device determines that at least a portion of the first identity signal corresponds to at least a portion of an expected identity signal and, if so, uses the at least a portion of the first identity signal and the at least a portion of the expected identity signal as encryption keys to provide encrypted communications. The first identity signal and/or the expected identity signal may be at least partially based upon or derived from the sensor signal(s) generated by the impact sensor(s).

### TECHNICAL FIELD

The present systems, devices, and methods generally relate to wearable electronic devices and particularly relate to encrypted communications between wearable electronic devices.

### BACKGROUND

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be “wireless” (i.e., designed to operate without any wire-connections to other, non-portable electronic systems); however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

Because wearable electronic devices are worn on the body of the user, visible to others, and generally present for long periods of time, form factor (i.e., size, geometry, and appearance) is a major design consideration in wearable electronic devices.

### BRIEF SUMMARY

A method for establishing encrypted communications between wearable electronic devices may be summarized as including: in response to a physical contact between a first wearable electronic device and a second wearable electronic device, generating a first sensor signal by a first impact sensor of the first wearable electronic device; transmitting, by the first wearable electronic device, a first identity signal based at least in part on at least a portion of the first sensor signal; receiving, by the second wearable electronic device, the first identity signal; determining, by the second wearable electronic device, that at least a portion of the first identity signal corresponds to at least a portion of an expected identity signal; and using the at least a portion of the first identity signal and the at least a portion of the expected identity signal as encryption keys to provide encrypted communications between the first wearable electronic device and the second wearable electronic device.

Prior to the physical contact between the first wearable electronic device and the second wearable electronic device, the method may include storing the first identity signal by the first wearable electronic device and storing the expected identity signal by the second wearable electronic device. The method may further include: providing a secure communication channel between the first wearable electronic device and the second wearable electronic device; and transmitting the expected identity signal from the first wearable electronic device to the second wearable electronic device via the secure communication channel. Providing a secure communication channel between the first wearable electronic device and the second wearable electronic device may include providing a secure wired communication channel between the first wearable electronic device and the second wearable electronic device within a connecting case.

Generating a first sensor signal by a first impact sensor of the first wearable electronic device may include generating a first impulse signal by the first impact sensor of the first wearable electronic device. Generating a first sensor signal by a first impact sensor of the first wearable electronic device may include generating, by the first impact sensor of the first wearable electronic device a first impact signal indicative of at least one attribute of the physical contact between the first wearable electronic device and the second wearable electronic device selected from a group consisting of: a direction of impact, a magnitude of impact, a speed of impact, and a duration of impact of the physical contact between the first wearable electronic device and the second wearable electronic device.

The method may further include: in response to the physical contact between the first wearable electronic device and the second wearable electronic device, generating a second sensor signal by a second impact sensor of the second wearable electronic device. In this case, the expected identity signal may include at least a portion of the second sensor signal and determining, by the second wearable electronic device, that at least a portion of the first identity signal corresponds to at least a portion of an expected identity signal may include determining, by the second wearable electronic device, that at least a portion of the first identity signal corresponds to at least a portion of the second sensor signal. The method may further include time-synchronizing the first wearable electronic device and the second wearable electronic device are time-synchronized, wherein the at least a portion of the first sensor signal and the at least a portion of the second sensor signal are both indicative of a time of the physical contact between the first wearable electronic device and the second wearable electronic device. The method may further include: generating, by the first wearable electronic device, a first encryption key based on a time of the first sensor signal, the first identity signal comprising the first encryption key; and generating, by the second wearable electronic device, a second encryption key based on a time of the second sensor signal, the expected identity signal comprising the second encryption key, wherein the first encryption key and the second encryption key together form a pair of encryption keys.

The physical contact between the first wearable electronic device and the second wearable electronic device may include a plurality of discrete contact events including a first contact event and at least a second contact event. Generating a first sensor signal by a first impact sensor of the first wearable electronic device in response to a physical contact between a first wearable electronic device and a second wearable electronic device may include generating the first sensor signal by the first impact sensor of the first wearable electronic device in response to the first contact event, and generating a second sensor signal by a second impact sensor of the second wearable electronic device in response to the physical contact between the first wearable electronic device and the second wearable electronic device may include generating the second sensor signal by the second impact sensor of the second wearable electronic device in response to the second contact event.

A system for encrypted communications between wearable electronic devices may be summarized as including: a first wearable electronic device having a first processor, a first non-transitory processor-readable storage medium communicatively coupled to the first processor, a first impact sensor communicatively coupled to the first processor, and a first communication interface communicatively coupled to the first processor; and a second wearable electronic device having a second processor, a second non-transitory processor-readable storage medium communicatively coupled to the second processor, and a second communication interface communicatively coupled to the second processor, wherein: the first impact sensor is responsive to generate a first sensor signal in response to a physical contact between the first wearable electronic device and the second wearable electronic device; the first communication interface is communicatively coupleable with the second communication interface to provide communications between the first wearable electronic device and the second wearable electronic device; the first non-transitory processor-readable storage medium of the first wearable electronic device stores processor-executable instructions that, when executed by the first processor, cause the first wearable electronic device to transmit, via the first communication interface, a first identity signal based at least in part on at least a portion of the first sensor signal; the second non-transitory processor-readable storage medium of the second wearable electronic device stores processor-executable instructions that, when executed by the second processor, cause the second wearable electronic device to determine that at least a portion of the first identity signal received by the second wearable electronic device via the second communication interface corresponds to at least a portion of an expected identity signal; and the processor-executable instructions stored in the first non-transitory processor-readable storage medium when executed by the first processor, and the processor-executable instructions stored in the second non-transitory processor-readable storage medium when executed by the second processor, cause the first wearable electronic device and the second wearable electronic device, respectively, to use at least a portion of the first identity signal and at least a portion of the expected identity signal as encryption keys to provide encrypted communications between the first wearable electronic device and the second wearable electronic device.

The system may further include a connecting case, wherein the connecting case includes a secure wired communication channel between the first wearable electronic device and the second wearable electronic device. The first sensor signal may include an impulse signal representative of the physical contact between the first wearable electronic device and the second wearable electronic device.

The second wearable electronic device may further include a second impact sensor communicatively coupled to the second processor, the second impact sensor responsive to generate a second sensor signal in response to the physical contact between the second wearable electronic device and the first wearable electronic device. The first identity signal may include at least a portion of the first sensor signal, and the expected identity signal may include at least a portion of the second sensor signal. The at least a portion of the first sensor signal and the at least a portion of the second sensor signal may be indicative of at least one attribute of the physical contact between the first wearable electronic device and the second wearable electronic device selected from a group consisting of: a direction of impact, a magnitude of impact, a speed of impact, and a duration of impact of the physical contact between the first wearable electronic device and the second wearable electronic device. The first wearable electronic device and the second wearable electronic device may be time-synchronized. The at least a portion of the first sensor signal and the at least a portion of the second sensor signal may be indicative of a time of the physical contact between the first wearable electronic device and the second wearable electronic device.

The processor-executable instructions stored in the first non-transitory processor-readable storage medium, when executed by the first processor, may cause the first processor to generate a first encryption key based on the time of the first sensor signal, the first identity signal comprising the first encryption key. The processor-executable instructions stored in the second non-transitory processor-readable storage medium, when executed by the second processor, may cause the second processor to generate a second encryption key based on the time of the second sensor signal, the expected identity signal comprising the second encryption key. The first encryption key and the second encryption key may form a pair of encryption keys. The physical contact between the first wearable electronic device and the second wearable electronic device may include a plurality of discrete contact events including at least a first contact event and a second contact event. Each of the first encryption key and the second encryption key may be generated based on a time of the first contact event and a time of the second contact event, respectively.

The second wearable electronic device may include a head mounted electronic display unit. The head mounted electronic display unit may include a pair of glasses.

The first wearable electronic device may include an electronic ring.

The first impact sensor and the second impact sensor may each include at least one sensor selected from a group comprising: an inertial sensor, an accelerometer, and a gyroscope.

The first communication interface of the first wearable electronic device may include a first wireless communication interface. The second communication interface of the second wearable electric device may include a second wireless communication interface. The first wireless communication interface may be wirelessly communicatively coupleable with the second wireless communication interface to provide wireless communications between the first wearable electronic device and the second wearable electronic device. The first non-transitory processor-readable storage medium of the first wearable electronic device may store processor-executable instructions that, when executed by the first processor, cause the first wearable electronic device to wirelessly transmit, via the first wireless communication interface, the first identity signal based at least in part on at least a portion of the first sensor signal. The second non-transitory processor-readable storage medium of the second wearable electronic device may store processor-executable instructions that, when executed by the second processor, cause the second wearable electronic device to determine that at least a portion of the first identity signal wirelessly received by the second wearable electronic device via the second wireless communication interface corresponds to at least a portion of the expected identity signal. The processor-executable instructions stored in the first non-transitory processor-readable storage medium when executed by the first processor, and the processor-executable instructions stored in the second non-transitory processor-readable storage medium when executed by the second processor, may cause the first wearable electronic device and the second wearable electronic device, respectively, to use at least a portion of the first identity signal and at least a portion of the expected identity signal as encryption keys to provide encrypted wireless communications between the first wearable electronic device and the second wearable electronic device.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a block diagram illustrating a wearable electronic device, according to one embodiment;

FIG. 2 is a block diagram illustrating a wearable electronic device communicating with an external electronic device, according to one embodiment;

FIGS. 3A to 3F are right side, front, left side, right perspective, top, and left perspective views, respectively, of a head mounted electronic display unit, an electronic ring, and a container for the electronic ring and the head mounted electronic display unit, according to at least one embodiment;

FIGS. 4A to 4F are right side, front, left side, right perspective, top, and left perspective views, respectively, of the head mounted electronic display unit and the electronic ring of FIGS. 3A to 3F stored in the container of FIGS. 3A to 3F;

FIGS. 5A to 5F are right side, front, left side, right perspective, top, and left perspective views, respectively, of the electronic ring in physical contact with a bridge of the head mounted electronic display unit of FIGS. 3A to 3F;

FIGS. 6A to 6F are right side, front, left side, right perspective, top, and left perspective views, respectively, of the electronic ring in physical contact with a right arm of the head mounted electronic display unit of FIGS. 3A to 3F;

FIGS. 7A to 7F are right side, front, left side, right perspective, top, and left perspective views, respectively, of the electronic ring in physical contact with a left arm of the head mounted electronic display unit of FIGS. 3A to 3F; and

FIG. 8 is a flow-diagram of a method of establishing encrypted communications between wearable electronic devices, according to at least one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

A user may use more than one electronic device at a time and it can be desirable for two or more electronic devices to communicate with one another. When such electronic devices are wearable, it is further desirable for the connection to be established in an efficient and repeatable manner because a user may put on and remove the wearable electronic devices often.

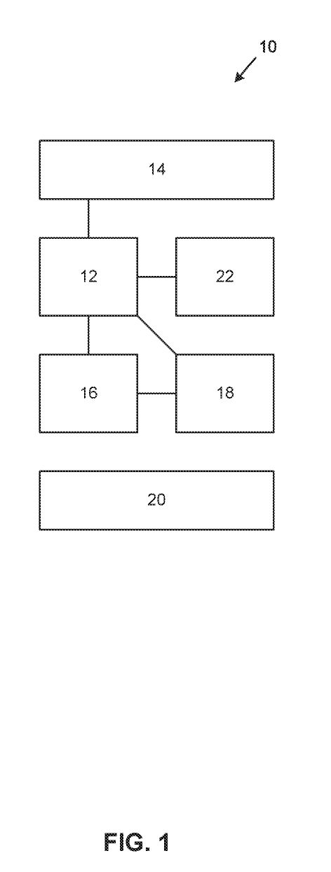

Referring now to FIG. 1, shown therein is a block diagram illustrating a wearable electronic device 10 in accordance with one or more implementations. Device 10 includes one or more non-transitory computer- or processor-readable storage media 12, one or more processors 14, one or more communication interfaces 16 (e.g., one or more tethered connector ports, radios and associated antennas (not shown)), an input/output (I/O) subsystem 18, an optional power system 20, and one or more sensors 22.

The one or more non-transitory computer- or processor-readable storage media 12 optionally includes high-speed random access memory and optionally also includes non-volatile memory, such as one or more magnetic disk storage devices, flash memory devices, or other non-volatile solid-state memory devices. Access to storage medium 12 by other components of wearable electronic device 10, such as processors 14 is, optionally, controlled by a memory controller (not shown), for example via a bus or other communications channel. The one or more non-transitory computer- or processor-readable media 12 stores processor-executable instructions, and/or data, executable by the one or more processors 14, and which when executed cause the one or more processors 14 to perform the various methods described herein.

The one or more processors 14 run or execute various software programs and/or sets of instructions stored in the one or more non-transitory computer- or processor-readable medial 2 to perform various functions for wearable electronic device 10 and to process data.

The one or more communication interfaces 16 receive and send signals (e.g., radio frequency RF or microwave frequency signals, also called electromagnetic signals). The one or more communication interfaces 16 convert electrical signals to/from electromagnetic signals and communicate with communications networks and other communications devices via the electromagnetic signals. The one or more communication interfaces 16 optionally include circuitry for performing such operations, including but not limited to a tethered connector port (e.g., USB®, Firewire®, Lightning® connector, etc.), an antenna system, an RF transceiver, one or more amplifiers, a tuner, one or more oscillators, a digital signal processor, a CODEC chipset, a subscriber identity module (SIM) card, memory, and so forth. The one or more communication interfaces 16 optionally communicate with networks, such as the Internet, an intranet and/or a wireless network, such as a cellular telephone network, a wireless local area network (LAN) and/or a metropolitan area network (MAN), and other devices by wireless communication.

I/O subsystem 18 couples input/output peripherals of wearable electronic device 10, such input or control devices, with a peripherals interface (not shown). I/O subsystem 18 can include a controller for each of the input or devices.

Power system 20 generally provides electrical power to the various components of the wearable electronic device 10 (not all connections shown). Power system 20 optionally includes a power management system, one or more power sources (e.g., primary battery cells, secondary power cells, fuel cells, super- or ultra-capacitors), a recharging system, a power failure detection circuit, a power converter or inverter, a power status indicator (e.g., a light-emitting diode (LED)) and any other components associated with the generation, management and distribution of power in portable devices. The recharging system may receive wired power (from e.g. a micro-USB charger) or wireless power via receipt of electromagnetic waves by one or more inductors or inductive interfaces, and provide the electrical power to the one or more power sources via one or more wired or electrically conductive paths.

Wearable electronic device 10 also includes one or more sensors 22. Sensors can include accelerometers, gyroscopes, magnetometers (e.g., as part of an inertial measurement unit (IMU)), vibration, shock, impact, and any other appropriate inertial sensors (herein referred to as impact sensors) to obtain information representative of a position, orientation, change in position and, or change in orientation (e.g., attitude), acceleration, angular velocity, and/or vibration of the wearable electronic device 10. In some implementations, these sensors can be coupled with a peripherals interface (not shown).

It should be appreciated that wearable electronic device 10 is only one example of a wearable electronic device, and that wearable electronic device 10 optionally has more or fewer components than shown, optionally combines two or more components, or optionally has a different configuration or arrangement of the components. The various components shown in FIG. 1 are implemented in hardware, software, firmware, or a combination thereof, including one or more signal processing and/or application specific integrated circuits.

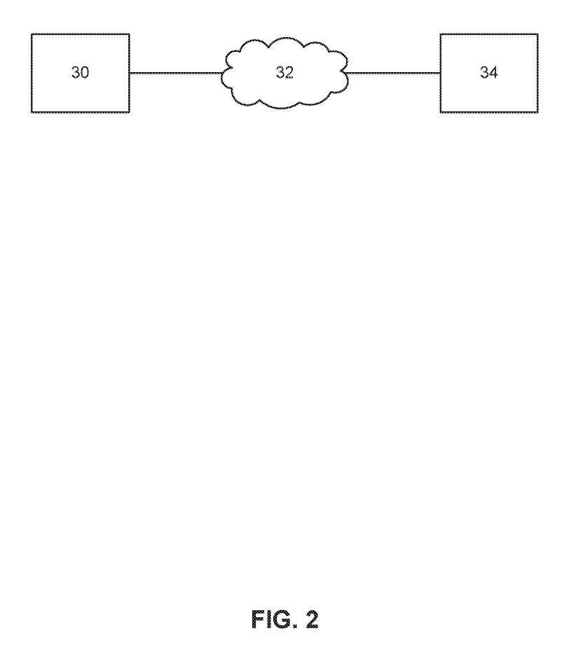

FIG. 2 is a block diagram illustrating a first wearable electronic device 30 communicating with a second wearable electronic device 34, in accordance with one or more implementations described herein. Second wearable electronic device 34 may include a display screen displaying a user interface for viewing by the user of the first wearable electronic device 30.

First wearable electronic device 30 communicates with second wearable electronic device 34 via a communications channel, for instance a communication network 32, which may be a wired connection, a Wi-Fi network, WiMAX, Zigbee, Z-Wave, Bluetooth™, Bluetooth™ Low Energy, near-field communication, or any other type of connection capable of providing uni-directional or bi-directional communication between the second wearable electronic device 34 and the first wearable electronic device 30.

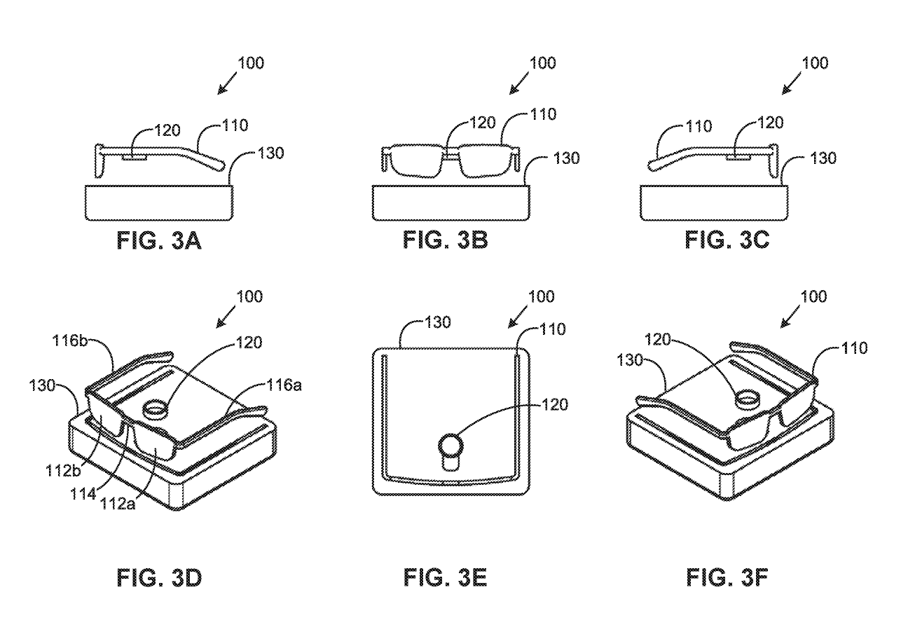

Referring now to FIGS. 3A to 3F (collectively referred to as FIG. 3 herein), shown therein are right side, front, left side, right perspective, top, and left perspective views, respectively, of a system 100 for establishing encrypted communications between wearable electronic devices. The system 100 includes a first and second wearable electronic devices. According to at least one implementation, the first wearable electronic device can be a head mounted electronic display unit 110 and the second wearable electronic device can be an electronic ring 120, as shown in FIG. 3. Optionally, the system 100 can also include a connecting case 130 for the wearable electronic devices. An example of a similar system is described in US Patent Application Publication 2017-0097753. As illustrated in FIGS. 3A to 3F, the head mounted electronic display unit 110 and the electronic ring 120 are each shown positioned outside of an interior of the connecting case 130.

The head mounted electronic display unit 110 can be glasses, as shown in FIG. 3D. The glasses include a frame holding a pair of lenses 112a and 112b (collectively referred to as 112 herein). The frame includes a bridge 114 between the lenses, as well as a right arm 116a and a left arm 116b (collectively referred to as 116 herein). The shape of the glasses is shown for illustrative purposes and is not limited to the illustrated shape. Other shapes can be used. Furthermore, other head mounted electronic display units 110 can be used. For example, a head mounted electronic display unit 110 may cover a portion of the user's head, such as a helmet, may rest on top of a user's head, and/or wrap around a user's head, such as a headband. A head mounted electronic display unit 110 may further include fastening or elastic members to secure to the user's head.

The electronic ring 120 can be worn around a finger of a user, for example a ring finger or an index finger on a hand of the user. The shape of the electronic ring 120 is shown for illustrative purposes and is not limited to the illustrated shape. Other shapes can be used. The electronic ring 120 can have any appropriate shape that allows the ring body to remain positioned around the finger of the user. For example, the electronic ring 120 can have a general shape of a circular band (open or closed), a helix, or a spiral. With a helix or spiral shape, the electronic ring 120 can have one or more turns. The electronic ring 120 can also have a break. With a break in the electronic ring 120, the electronic ring may expand to accommodate or tolerate fingers having different ring sizes. Some example systems and devices that may be included in the electronic ring 120 are described in U.S. Provisional Patent Application Ser. No. 62/607,819 and U.S. Provisional Patent Application Ser. No. 62/608,463.

As shown in FIG. 3E, the connecting case 130 can have an interior or recesses and be shaped to receive the first wearable electronic device 110 and/or the second wearable electronic device 120. The shape of the connecting case 130 is shown for illustrative purposes and is not limited to the illustrated shape. As shown in FIG. 3, the connecting case 130 can receive both the first wearable electronic device 110 and the second wearable electronic device 120. That is, the connecting case 130 can receive the head mounted electronic display unit 110 and the electronic ring 120. In some implementations, the connecting case 130 can receive only one wearable electronic device. When the connecting case 130 receives only one wearable electronic device, the connecting case 130 can include a connection port to communicatively couple to a second wearable electronic device or a second connecting case that holds the second wearable electronic device.

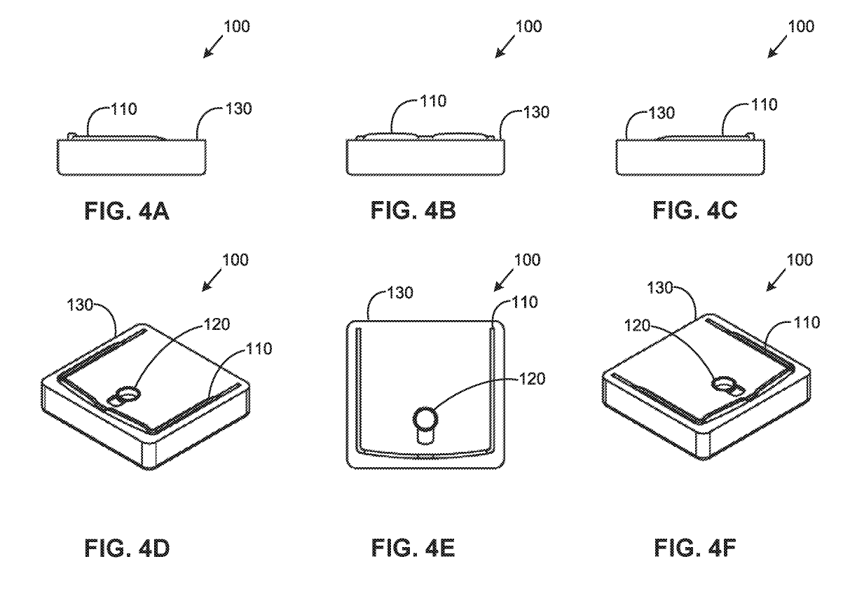

Referring now to FIGS. 4A to 4F (collectively referred to as FIG. 4 herein), shown therein are right side, front, left side, right perspective, top, and left perspective views of the head mounted electronic display 110 unit and the electronic ring 120 illustrated as stored at least partially within an interior of the connecting case 130 of FIG. 3. The connecting case 130 can also include a lid (not shown) and/or fastening means (not shown) for retaining the wearable electronic devices 110, 120 within the connecting case 130. The connecting case 130 can have a rigid outer shell to protect the wearable electronic devices 110 and 120 stored therein. The connecting case 130 can include one or more chargers to charge either or both of the head mounted electronic display unit 110 and/or the electronic ring 120. A charger may employ, for example, a magnetic connector such as that described in U.S. Provisional Patent Application Ser. No. 62/608,385.

The connecting case 130 can couple the wearable electronic devices, thereby providing a secure communication channel between the wearable electronic devices. The secure communication channel can be a wired or a wireless connection. Furthermore, in some implementations, the secure communication channel can be a wired connection to a first wearable electronic device and a wireless connection to a second wearable electronic device.

The secure communication channel can be used to transfer data between the wearable electronic devices 110, 120. In addition, each of the head mounted electronic display unit 110 and the electronic ring 120 can include an internal clock, which can be time-synchronized together. In some implementations, the internal clocks of the wearable electronic devices can be time-synchronized via an unsecure communication channel. In some implementations, the internal clocks can be time-synchronized via the secure communication channel. In some embodiments, the internal clocks can be time-synchronized via encrypted communications. Throughout this specification and the appended claims, the term “time-synchronized” is used to refer to at least two separate devices that have separate means (i.e., clocks) to keep track of the passage of time, and whose respective separate means (i.e., clocks) to keep track of the passage of time are sufficiently temporally aligned so that, at any given time, each device could identify the time that the other device would measure/report within less than 0.1 s.

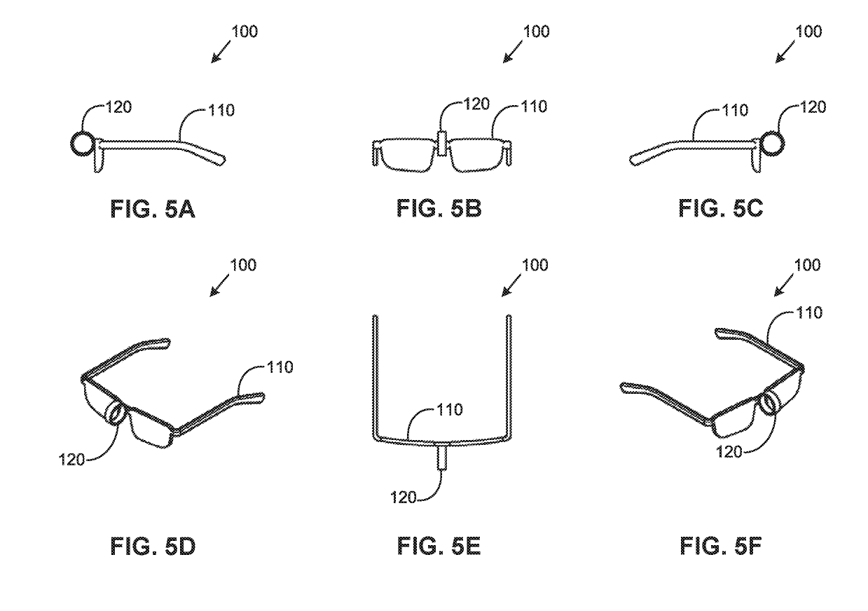

Referring now to FIGS. 5A to 5F (collectively referred to as FIG. 5 herein), shown therein are right side, front, left side, right perspective, top, and left perspective views of the electronic ring 120 in physical contact with the head mounted electronic display unit 110 of FIG. 3. Physical contact between the electronic ring 120 and the head mounted electronic display 110 may occur at the bridge 114 of the head mounted electronic display 110. For example, the electronic ring 120 can be brought into physical contact with the bridge 114 of the head mounted electronic display unit 110 as shown in FIG. 5 while a user is wearing one, both, or neither of the electronic ring 120 and the head mounted electronic display unit 110. Physical contact at/with bridge 114 of head mounted electronic display unit 110 is used here for illustrative purposes only. In alternative implementations, such physical contact may occur at another position on head mounted electronic display unit 100, such as at either arm 116 of head mounted electronic display unit 110.

The head mounted electronic display unit 110 and the electronic ring 120 each include an impact sensor (not shown in FIG. 5). The impact sensors each generate a sensor signal with information about the respective wearable electronic device. For example, in response to a physical contact between the head mounted electronic display unit 110 and the electronic ring 120 (e.g., if and when the head mounted electronic display 110 and the electronic ring 120 are brought into physical contact with one another, such as shown in FIG. 5), the impact sensors of each wearable electronic device can generate a sensor signal indicative of the wearable electronic device being in physical contact with, or impacting, another object.

In some implementations, received signal strength may be used as an indicator (“RSSI”) of close proximity between the head mounted electronic display unit 110 and the electronic ring 120 instead of signals from impact sensors resulting from physical contact. For example, in lieu of physical contact, the head mounted electronic display unit 110 and the electronic ring 120 may implement the systems and methods for establishing proximity-based wireless connections described in US Patent Application Publication No. 2015-0296553.

In some implementations, the impact sensor can output an impulse signal when impact of the physical contact between the two wearable electronic devices is detected. That is, the sensor signal can represent an impulse when impact occurs. In some implementations, the sensor signal can be indicative of a direction of impact, a magnitude of impact, a speed of impact, and a duration of impact of the physical contact between the first wearable electronic device and the second wearable electronic device. The processor of a wearable electronic device can monitor the sensor signal to determine if the sensor signal satisfies a threshold magnitude and/or duration indicative of physical contact with another wearable electronic device. The threshold magnitude and/or duration can be minimum and/or maximum thresholds.

The sensor signal of the head mounted electronic display unit 110 can be analyzed to determine a location at which the physical contact takes place. In particular, the magnitude of impact can be different depending on the location at which the physical contact takes place relative to the location of the sensor within the head mounted electronic display unit 110. In some instances, the threshold magnitude may be more readily exceeded when the physical contact takes place at a location that is in close proximity to the impact sensor compared to at a location that is more distant from the impact sensor.

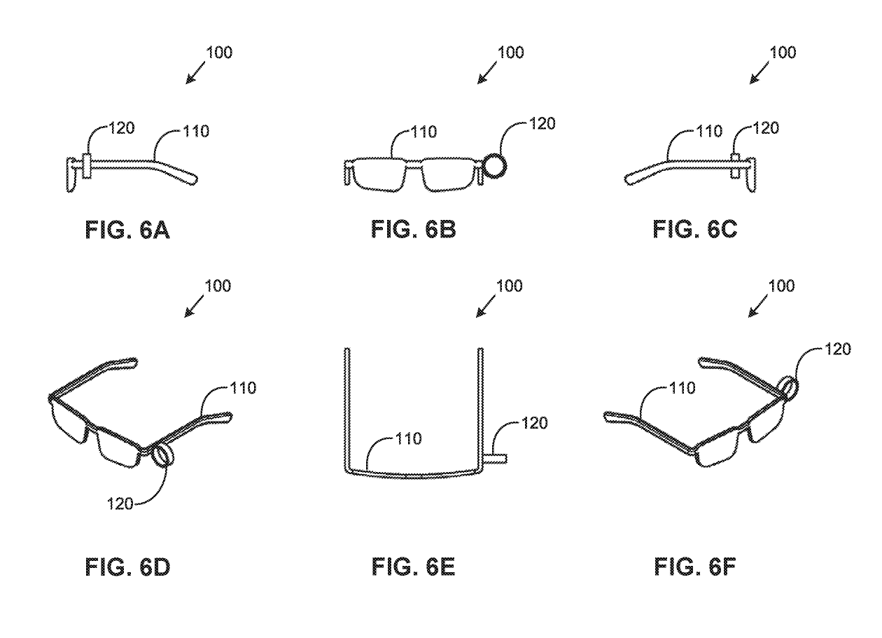

For example, FIG. 5 shows the electronic ring 120 in physical contact with the bridge 114 of the head mounted electronic display unit 110. Such may be particularly advantageous, for example, when the impact sensor of head mounted electronic display unit 110 is physically located at, within, or in close proximity to (i.e., within two centimeters of) bridge 114. In contrast, the electronic ring 120 can be in physical contact with an arm 116 of the head mounted electronic display unit 110. Referring now to FIGS. 6A to 6F (collectively referred to as FIG. 6 herein), shown therein are right side, front, left side, right perspective, top, and left perspective views of the electronic ring 120 in physical contact with a right arm 116a of the head mounted electronic display unit 110 of FIG. 3. In particular, a side surface of the electronic ring 120 is in physical contact with the head mounted electronic display unit 110 as shown in FIG. 6. The side surface of the electronic ring 120 can be in (e.g., can be brought into) physical contact with the head mounted electronic display unit 110 while a user is wearing one, both, or neither of the electronic ring 120 and the head mounted electronic display unit 110. The physical contact with right arm 116a depicted in FIG. 6 may be particularly advantageous when the impact sensor of head mounted electronic display unit 110 is physically located at, within, or in close proximity to (i.e., within two centimeters of) right arm 116a.

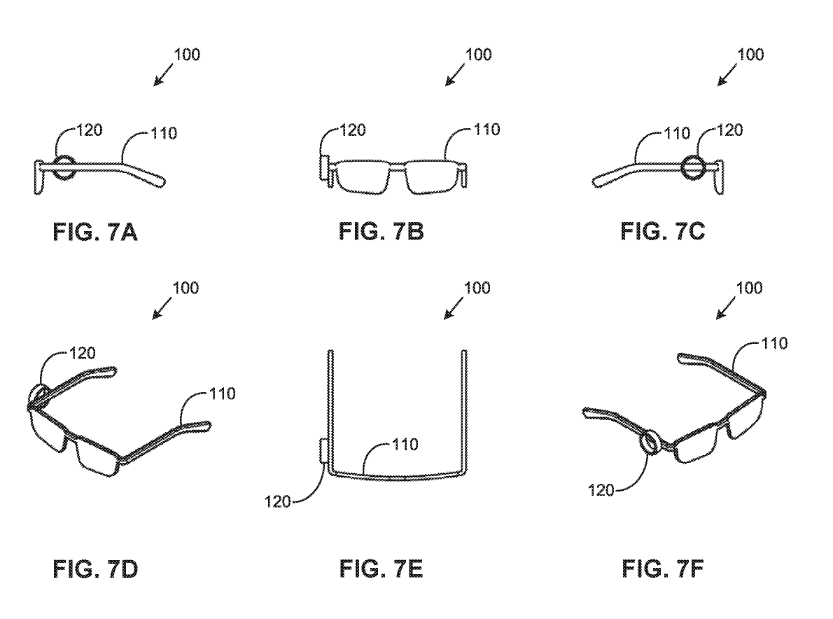

Referring now to FIGS. 7A to 7F (collectively referred to as FIG. 7 herein), shown therein are right side, front, left side, right perspective, top, and left perspective views of the electronic ring 120 in physical contact with a left arm 116b of the head mounted electronic display unit 110 of FIG. 3. In contrast to FIG. 6, in FIG. 7, an end face of the electronic ring 120 is in physical contact with the head mounted electronic display unit 110. When the end face of the electronic ring 120 is in (e.g., is brought into) physical contact with the head mounted electronic display unit 110, the user may be wearing or not wearing the head mounted electronic display unit 110 however, the user is not wearing the electronic ring 120. The physical contact with left arm 116b depicted in FIG. 7 may be particularly advantageous when the impact sensor of head mounted electronic display unit 110 is physically located at, within, or in close proximity to (i.e., within two centimeters of) left arm 116b.

The sensor signal of the electronic ring 120 can be analyzed to determine a direction of impact of the electronic ring 120 (e.g., based on data from one or more accelerometers, gyroscopes, magnetometers, or inertial sensors in general), which can for example, indicate the orientation of the electronic ring 120 during physical contact with the head mounted electronic display unit 110 as shown in FIG. 6 or 7.

Physical contact between wearable electronic devices may refer to bumping or tapping the wearable electronic devices together. Bumping or tapping can be a quick and easy act to perform. In some implementations, physical contact can be a single tap or bump. In some implementations, physical contact can include a sequence of taps. That is, physical contact can be a plurality of discrete contact events with a first contact event and at least a second contact event.

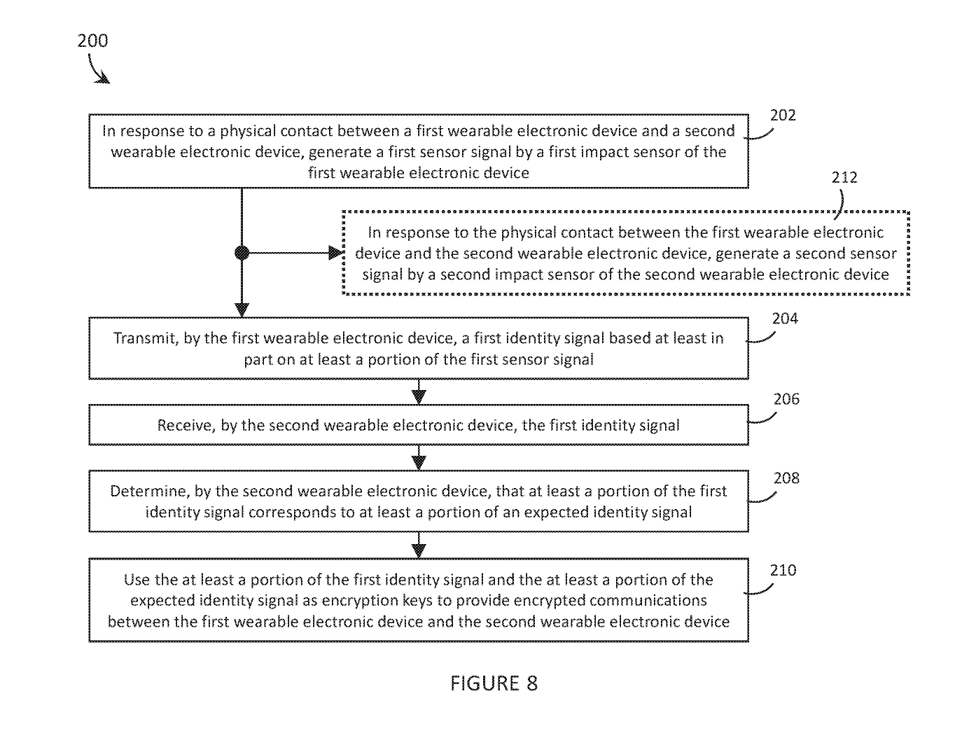

Referring now to FIG. 8, shown therein is a flow-diagram of method 200 for establishing encrypted communication between wearable electronic devices in accordance with the present systems, devices, and methods. The wearable electronic devices may be substantially similar to the wearable electronic devices 10, 30, and 34 of FIGS. 1 and 2, and the head mounted electronic display unit 110 and the electronic ring 120 of FIGS. 3 to 7. Furthermore, while method 200 is described with the electronic ring 120 as a first wearable electronic device and the head mounted electronic display unit 110 as a second wearable electronic device, those of skill in the art will understand that the head mounted electronic display unit 110 can act as the first wearable electronic device and the electronic ring 120 can act as the second wearable electronic device. Furthermore, the first wearable electronic device and the second wearable electronic device can be any wearable electronic devices.

Method 200 includes five acts 202, 204, 206, 208, and 210 though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

Act 202 is triggered or effected in response to a physical contact between the first wearable electronic device and the second wearable electronic device. For example, act 202 may be triggered in response to the user bringing the first wearable electronic device and the second wearable electronic device 120 into physical contact with one another as illustrated in, for example, FIGS. 5, 6, and 7. The physical contact can include a single bump or a plurality of bumps. A first impact sensor within the electronic ring 120, for example, generates a first sensor signal upon detection of the physical contact. The first sensor signal generated by the first impact sensor of the first wearable electronic device may be indicative of at least one attribute of the physical contact between the first wearable electronic device and the second wearable electronic device, such as: a direction of impact, a magnitude of impact, a speed of impact, and/or a duration of impact of the physical contact between the first wearable electronic device and the second wearable electronic device.

Method 200 optionally includes act 212. Act 212 may be triggered/effected in tandem with act 202 in response to the physical contact between the first wearable electronic device and the second wearable electronic device. At 212, a second impact sensor within the head mounted electronic display unit 110, for example, generates a second sensor signal upon detection of the physical contact. Whether or not act 212 is performed depends on whether or not the particular implementation of method 200 has a need of or use for a second sensor signal.

At 204, the first wearable electronic device transmits a first identity signal based at least in part on at least a portion of the first sensor signal. Transmission of the first identity signal can be a broadcast of the first identity signal. That is, transmission of the first identity signal may not be directed specifically at or address a particular receiver such as the head mounted electronic display unit 110. In some implementations, the processor of the electronic ring 120 can monitor an output of the first impact sensor and upon identifying that impact has occurred (based on, for example, a spike in the output of the first impact sensor), initiate the transmission of the first identity signal. In some implementations, the processor of the electronic ring 120 can be manually set to a broadcast mode prior to the physical contact taking place. Manually setting the electronic ring 120 to a broadcast mode can relate to manipulating a manual button or other input mechanism of the electronic ring 120. Once bumped, the broadcast mode may result in the transmission of the first identity signal.

In some implementations, the first identity signal can be stored in the storage medium 12 of the electronic ring 120 before the physical contact occurs between the first wearable electronic device and the second wearable electronic device. Storage of the first identity signal can be a factory default. Alternatively, the first identity signal can be transferred to the first wearable electronic device via a secure communication channel provided by the connecting case 130, and optionally from the second wearable electronic device. In some implementations, the first identity signal can relate to or include an identifier for the electronic ring 120. In some implementations, the first identity signal can be, encode, or carry an encryption key, and more specifically a generic encryption key.

In some implementations, the first identity signal can be based on (e.g., include or be derived from), at least in part, the first sensor signal. In this sense, the first identity signal can be a signature of the first sensor signal. For example, the first identity signal can include a portion of the first sensor signal, and in particular, the impulse signal generated by the physical contact. In some implementations when internal clocks of the wearable electronic devices are time-synchronized, the first identity signal can indicate the time of the physical contact. When the physical contact includes a sequence of tapping, the first identity signal can indicate the start time and the end time of the sequence of tapping. Alternatively, the first identity signal can relate to a pattern of the sequence of tapping. Furthermore, in some implementations, the time of the physical contact, as reported or indicated by the internal clock, can be used to generate an encryption key. Any suitable algorithm can be used to generate an encryption key from the time reported by the internal clock or the pattern of the sequence of tapping.

At 206, the second wearable electronic device receives the first identity signal. Reception of the first identity signal by the second wearable electronic device can be achieved, for example, when the second wearable electronic device is operating in a search or a listening mode for any signals. That is, reception of the first identity signal may not be directed at signals from a particular transmitter such as the electronic ring 120. In some implementations, the processor of the head mounted electronic display unit 110 can be manually set to a listening mode prior to the physical contact taking place. Manually setting the head mounted electronic display unit 110 to a listening mode can relate to manipulating a manual button or other input mechanism of the head mounted electronic display unit 110. Once bumped, the first wearable electronic device transmits the first identity signal and the listening mode of the second wearable electronic device can receive the first identity signal. In implementations of method 200 that include optional act 212, the processor of the head mounted electronic display unit 110 can monitor the second sensor signal and upon identifying that impact has occurred, initiate the listening mode in order to receive the first identity signal.

At 208, the second wearable electronic device determines that at least a portion of the first identity signal corresponds to at least a portion of an expected identity signal. In general, at 208 the second wearable electronic device may determine whether or not at least a portion of the first identity signal corresponds to at least a portion of an expected identity signal, but method 200 only progresses from act 208 to act 210 when at least a portion of the first identity signal does correspond to at least a portion of the expected identity signal. The determination of whether respective portions of the first identity signal and the expected identity signal correspond to one another can involve any appropriate comparison algorithm. For instance, the determination can involve a direct comparison of the two signals. In some implementations, the determination can involve a comparison of a transformation of one or both of the signals. For the purposes of this specification and the appended claims, the term “correspond” in the context of at least a portion of a first identity signal and at least a portion of an expected identity signal means the two (portions of) signal match, align, or otherwise compare in a way that is indicative of a sufficient similarity between the two (portions) of signals. “Sufficient,” in this context, depends on the nature of the particular comparison algorithm being employed and generally invokes a minimum “similarity” threshold for whatever parameter is being compared (e.g., the same within 80%).

The nature of the expected identity signal may generally be analogous to the first identity signal and may optionally be identical to the first identity signal. When the first identity signal is stored in the storage medium 12 of the electronic ring 120, the expected identity signal may also be stored (i.e., in the storage medium 12 of the head mounted electronic display unit 110). Storage of the expected identity signal can also be a factory default. Alternatively, the expected identity signal can be transferred to the second wearable electronic device via a secure communication channel provided by the connecting case 130, and optionally from the first wearable electronic device. The expected identity signal can also be an encryption key that corresponds to the encryption key of the first identity signal. That is, the encryption key of the first identity signal and the encryption key of the expected identity signal can form a pair of encryption keys.

In implementations of method 200 that include optional act 212, the expected identity signal can be based on (e.g., include or be derived, at least in part, from) the second sensor signal. In this sense, the expected identity signal can be a signature of the second sensor signal. For example, the expected identity signal can include a portion of the second sensor signal, and in particular, the impulse signal generated by the physical contact. In some implementations when internal clocks of the wearable electronic devices are time-synchronized, the expected identity signal can indicate the time of the physical contact. When the physical contact includes a sequence of tapping, the expected identity signal can indicate the start time and the end time of the sequence of tapping. Alternatively, the expected identity signal can relate to a pattern of the sequence of tapping. Furthermore, in some implementations, the time of the physical contact can be used to generate an encryption key. Again, the encryption key of the first identity signal and the encryption key of the expected identity signal can form a pair of encryption keys.

At 210, the at least a portion of the first identity signal and the at least a portion of the expected identity signal are used by the first wearable electronic device and the second wearable electronic device as encryption keys to provide encrypted communications between the first wearable electronic device and the second wearable electronic device. That is, the first wearable electronic device can encrypt data using at least a portion of the first identity signal prior to transmitting, or broadcasting the data. While any electronic device can receive the encrypted data that is broadcasted by the first wearable electronic device, only devices having the expected identity signal can decrypt the encrypted data. Likewise, the second wearable electronic device can encrypt data using at least a portion of the expected identity signal and the first wearable electronic device can decrypt data using at least a portion of the first identity signal.

Furthermore, the encrypted communications can be refreshed by bumping the first wearable electronic device and the second wearable electronic device together again to generate another set of encryption keys. In some implementations, two wearable electronic devices can initially use stored identity signals, such as generic encryption keys, to establish encrypted communications from a first physical contact (i.e., a first bump). The encrypted communications can then be used to time-synchronize internal clocks of the two wearable electronic devices. Subsequently, the two wearable devices can be bumped together again (i.e., a second bump) to generate more secure encryption keys, that is, a first identity signal and an expected identity signal that are derived from the second bump, or a signature of the second bump. In this scenario, the second set of encryption keys may be more secure than the first set of encryption keys because the second set of encryption keys relate to the bump itself as opposed to being stored, generic keys.

In some embodiments, a second wearable electronic device can connect to a plurality of first wearable electronic devices. That is, prior to a bump, the second wearable electronic device can receive signals from a plurality of electronic devices in listening mode. The first wearable electronic device may transmit a generic signal in broadcast mode. Once the bump occurs, the first wearable electronic device transmits the first identity signal containing an impulse indicative of the bump. The second wearable electronic device can identify the impulse and based on the identification, validate or confirm the connection between the first wearable electronic device and the second wearable electronic device.

In some embodiments, subsequent bumps can command different actions. For example, the wearable electronic devices can be configured to discard the encryption keys upon a second bump, thus discontinuing the encrypted communication.

Furthermore, in some embodiments, the direction and the location of impact can command different actions. For example, physical contact between an end face of the electronic ring 120 and the head mounted electronic display unit 110, as shown in FIG. 7, can be indicative of a first bump and the wearable electronic devices can use generic encryption keys. Subsequent bumps may require a side surface of the electronic ring 120 in physical contact with the head mounted electronic display unit 110 and can trigger different responses, actions, effects, or the employment of different encryption keys, depending on the specific application.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including without limitation US Patent Application Publication 2017-0097753, U.S. Provisional Patent Application Ser. No. 62/607,819, U.S. Provisional Patent Application Ser. No. 62/608,463, U.S. Provisional Patent Application Ser. No. 62/608,385, and US Patent Application Publication No. 2015-0296553, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for establishing encrypted communications between wearable electronic devices, the method comprising:
in response to a physical contact between a first wearable electronic device and a second wearable electronic device, generating a first sensor signal by a first impact sensor of the first wearable electronic device;
transmitting, by the first wearable electronic device, a first identity signal based at least in part on at least a portion of the first sensor signal;
receiving, by the second wearable electronic device, the first identity signal;
determining, by the second wearable electronic device, that at least a portion of the first identity signal corresponds to at least a portion of an expected identity signal; and
using the at least a portion of the first identity signal and the at least a portion of the expected identity signal as encryption keys to provide encrypted communications between the first wearable electronic device and the second wearable electronic device.

2. The method of claim 1, further comprising:
prior to the physical contact between the first wearable electronic device and the second wearable electronic device, storing the first identity signal by the first wearable electronic device and storing the expected identity signal by the second wearable electronic device.

3. The method of claim 2, further comprising:
providing a secure communication channel between the first wearable electronic device and the second wearable electronic device; and
transmitting the expected identity signal from the first wearable electronic device to the second wearable electronic device via the secure communication channel.

4. The method of claim 3 wherein providing a secure communication channel between the first wearable electronic device and the second wearable electronic device includes providing a secure wired communication channel between the first wearable electronic device and the second wearable electronic device within a connecting case.

5. The method of claim 1, further comprising:
in response to the physical contact between the first wearable electronic device and the second wearable electronic device, generating a second sensor signal by a second impact sensor of the second wearable electronic device, wherein the expected identity signal comprises at least a portion of the second sensor signal, and wherein determining, by the second wearable electronic device, that at least a portion of the first identity signal corresponds to at least a portion of an expected identity signal includes determining, by the second wearable electronic device, that at least a portion of the first identity signal corresponds to at least a portion of the second sensor signal.

6. The method of claim 5, further comprising time-synchronizing the first wearable electronic device and the second wearable electronic device are time-synchronized, wherein the at least a portion of the first sensor signal and the at least a portion of the second sensor signal are both indicative of a time of the physical contact between the first wearable electronic device and the second wearable electronic device.

7. The method of claim 6, further comprising:
generating, by the first wearable electronic device, a first encryption key based on a time of the first sensor signal, the first identity signal comprising the first encryption key; and
generating, by the second wearable electronic device, a second encryption key based on a time of the second sensor signal, the expected identity signal comprising the second encryption key, wherein the first encryption key and the second encryption key together form a pair of encryption keys.

8. The method of claim 7 wherein:
the physical contact between the first wearable electronic device and the second wearable electronic device comprises a plurality of discrete contact events including a first contact event and at least a second contact event;
generating a first sensor signal by a first impact sensor of the first wearable electronic device in response to a physical contact between a first wearable electronic device and a second wearable electronic device includes generating the first sensor signal by the first impact sensor of the first wearable electronic device in response to the first contact event; and
generating a second sensor signal by a second impact sensor of the second wearable electronic device in response to the physical contact between the first wearable electronic device and the second wearable electronic device includes generating the second sensor signal by the second impact sensor of the second wearable electronic device in response to the second contact event.

9. A system for encrypted communications between wearable electronic devices, the system comprising:
a first wearable electronic device having a first processor, a first non-transitory processor-readable storage medium communicatively coupled to the first processor, a first impact sensor communicatively coupled to the first processor, and a first communication interface communicatively coupled to the first processor; and
a second wearable electronic device having a second processor, a second non-transitory processor-readable storage medium communicatively coupled to the second processor, and a second communication interface communicatively coupled to the second processor, wherein:
the first impact sensor is responsive to generate a first sensor signal in response to a physical contact between the first wearable electronic device and the second wearable electronic device;
the first communication interface is communicatively coupleable with the second communication interface to provide communications between the first wearable electronic device and the second wearable electronic device;
the first non-transitory processor-readable storage medium of the first wearable electronic device stores processor-executable instructions that, when executed by the first processor, cause the first wearable electronic device to transmit, via the first communication interface, a first identity signal based at least in part on at least a portion of the first sensor signal;
the second non-transitory processor-readable storage medium of the second wearable electronic device stores processor-executable instructions that, when executed by the second processor, cause the second wearable electronic device to determine that at least a portion of the first identity signal received by the second wearable electronic device via the second communication interface corresponds to at least a portion of an expected identity signal; and
the processor-executable instructions stored in the first non-transitory processor-readable storage medium when executed by the first processor, and the processor-executable instructions stored in the second non-transitory processor-readable storage medium when executed by the second processor, cause the first wearable electronic device and the second wearable electronic device, respectively, to use at least a portion of the first identity signal and at least a portion of the expected identity signal as encryption keys to provide encrypted communications between the first wearable electronic device and the second wearable electronic device.

10. The system of claim 9, further comprising a connecting case, wherein the connecting case includes a secure wired communication channel between the first wearable electronic device and the second wearable electronic device.

11. The system of claim 9 wherein the first sensor signal comprises an impulse signal representative of the physical contact between the first wearable electronic device and the second wearable electronic device.

12. The system of claim 9 wherein the second wearable electronic device further includes a second impact sensor communicatively coupled to the second processor, the second impact sensor responsive to generate a second sensor signal in response to the physical contact between the second wearable electronic device and the first wearable electronic device.

13. The system of claim 12 wherein:
the first identity signal comprises at least a portion of the first sensor signal; and
the expected identity signal comprises at least a portion of the second sensor signal.

14. The system of claim 13 wherein the at least a portion of the first sensor signal and the at least a portion of the second sensor signal are indicative of at least one attribute of the physical contact between the first wearable electronic device and the second wearable electronic device selected from a group consisting of: a direction of impact, a magnitude of impact, a speed of impact, and a duration of impact of the physical contact between the first wearable electronic device and the second wearable electronic device.

15. The system of claim 14 wherein:
the first wearable electronic device and the second wearable electronic device are time-synchronized; and
the at least a portion of the first sensor signal and the at least a portion of the second sensor signal are indicative of a time of the physical contact between the first wearable electronic device and the second wearable electronic device.

16. The system of claim 15 wherein:
the processor-executable instructions stored in the first non-transitory processor-readable storage medium, when executed by the first processor, cause the first processor to generate a first encryption key based on the time of the first sensor signal, the first identity signal comprising the first encryption key; and
the processor-executable instructions stored in the second non-transitory processor-readable storage medium, when executed by the second processor, cause the second processor to generate a second encryption key based on the time of the second sensor signal, the expected identity signal comprising the second encryption key, and wherein the first encryption key and the second encryption key form a pair of encryption keys.

17. The system of claim 16 wherein:
the physical contact between the first wearable electronic device and the second wearable electronic device comprises a plurality of discrete contact events including at least a first contact event and a second contact event; and
each of the first encryption key and the second encryption key are generated based on a time of the first contact event and a time of the second contact event, respectively.

18. The system of claim 9 wherein the second wearable electronic device comprises a head mounted electronic display unit.

19. The system of claim 9 wherein the first wearable electronic device comprises an electronic ring.

20. The system of claim 9 wherein:
the first communication interface of the first wearable electronic device is a first wireless communication interface;
the second communication interface of the second wearable electric device is a second wireless communication interface;
the first wireless communication interface is wirelessly communicatively coupleable with the second wireless communication interface to provide wireless communications between the first wearable electronic device and the second wearable electronic device;
the first non-transitory processor-readable storage medium of the first wearable electronic device stores processor-executable instructions that, when executed by the first processor, cause the first wearable electronic device to wirelessly transmit, via the first wireless communication interface, the first identity signal based at least in part on at least a portion of the first sensor signal;
the second non-transitory processor-readable storage medium of the second wearable electronic device stores processor-executable instructions that, when executed by the second processor, cause the second wearable electronic device to determine that at least a portion of the first identity signal wirelessly received by the second wearable electronic device via the second wireless communication interface corresponds to at least a portion of the expected identity signal; and
the processor-executable instructions stored in the first non-transitory processor-readable storage medium when executed by the first processor, and the processor-executable instructions stored in the second non-transitory processor-readable storage medium when executed by the second processor, cause the first wearable electronic device and the second wearable electronic device, respectively, to use at least a portion of the first identity signal and at least a portion of the expected identity signal as encryption keys to provide encrypted wireless communications between the first wearable electronic device and the second wearable electronic device.
